(19) United States
(12) Patent Application Publication
(10) Pub. No.: US 2008/0137122 A1
(43) Pub. Date: Jun. 12, 2008

(54) IMAGE-DISPLAYING SHEET, IMAGE FORMING APPARATUS, DISPLAY CONTROL METHOD OF IMAGE-DISPLAYING SHEET, AND DISPLAY CONTROL PROGRAM

(75) Inventors: Hiroshi Eguchi, Okazaki-shi (JP); Tatsuya Eguchi, Toyohashi-shi (JP); Kiyohito Tsujihara, Hoi-gun (JP); Shigeo Tomita, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/933,926

(22) Filed: Nov. 1, 2007

(30) Foreign Application Priority Data
Dec. 11, 2006 (JP) 2006-333880

(51) Int. Cl. G06F 3/12

(52) U.S. Cl. 358/1.13

(57) ABSTRACT

An image-displaying sheet, comprising: a display that displays an image thereon; a switch part that switches ON and OFF the mode to display an image on the display; a copy detector that detects a copy operation performed on an image displayed on the display; and a controller that makes the switch part switch OFF the mode to display an image on the display, if the copy detector detects that a copy operation is performed on the image.

This application claims priority under 35 U.S.C. § 119 to Japanese Patent Application No. 2006-333880 filed on Dec. 11, 2006, the entire disclosure of which is incorporated herein by reference in its entirety.

### BACKGROUND OF THE INVENTION

1. Field of the Invention

The present invention relates to an image-displaying sheet such as electronic paper, an image forming apparatus such as a MFP (Multi Function Peripheral) that is a digital multifunctional machine capable of copying an image displayed on the image-displaying sheet, a display control method of the image-displaying sheet, and a display control program that is stored in a computer readable recording medium to make a computer execute display control processing by the display control method.

2. Description of the Related Art

The following description sets forth the inventor's knowledge of related art and problems therein and should not be construed as an admission of knowledge in the prior art.

As is well known, electronic paper is an image-displaying sheet, and comprises a display keeping an image displayed thereon without power supply. Electronic paper is used repeatedly, since it hides and rewrites an image displayed on its display not like an ordinary sheet having an image printed thereon. Thus, the use of electronic paper is socially promoted from the viewpoint of economy in paper resources.

However, it is an issue with the use of electronic paper, that paid images or confidential images displayed thereon may be abusively copied and leaked by a third person who happens to obtain the electronic paper, because it keeps an image displayed thereon.

According to an art disclosed in Japanese Laid-open Patent Publication No. 2005-12701, copy permission information is written in a contactless IC chip embedded in electronic paper that is a document, and not only an image on the electronic paper but also the copy permission information in the IC chip are read by a copier, and if “copy prohibit” is detected from the copy permission information, then the document is prohibited from being copied.

Further, according to an art disclosed in Japanese Laid-open Patent Publication No. 2006-39107, electronic paper has an area detection function, and if the electronic paper is moved out of a predetermined area, then an image displayed thereon is hidden.

However, in the art disclosed in Japanese Laid-open Patent Publication No. 2005-12701, it is judged by a copier itself whether or not to prohibit a document from being copied. Therefore, an image on a document may be permitted to be copied by a copier not having a copy prohibit function, even if the document has “copy prohibit” information. Thus, the art does not fully eliminate the risk of leakage of an image.

Further, in the art disclosed in Japanese Laid-open Patent Publication No. 2006-39107, an image on electronic paper is permitted to be copied as long as it is moved within a predetermined area. Thus, the art does not fully eliminate the risk of leakage of an image, either.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image-displaying sheet that ensures security of an image displayed thereon by preventing the image from being abusively copied and leaked.

It is another object of the present invention to provide an image forming apparatus that ensures security of an image displayed on the image-displaying sheet by preventing the image from being abusively copied and leaked.

It is yet another object of the present invention to provide a display control method of the image-displaying sheet, which ensures security of an image displayed thereon by preventing the image from being abusively copied and leaked.

It is still yet another object of the present invention to provide a display control program stored in a computer readable recording medium to make a computer execute display control processing by the display control method of the image-displaying sheet.

According to a first aspect of the present invention, an image-displaying sheet comprises:
a display that displays an image thereon;
a switch part that switches ON and OFF the mode to display an image on the display;
a copy detector that detects a copy operation performed on an image displayed on the display; and
a controller that makes the switch part switch OFF the mode to display an image on the display, if the copy detector detects that a copy operation is performed on the image.

According to a second aspect of the present invention, an image forming apparatus comprises:
an acceptor that accepts a copy start instruction given by a user to copy an image-displaying sheet placed on a document table; and
a controller that makes copy start signals transmitted to the image-displaying sheet, if a copy start instruction is accepted.

According to a third aspect of the present invention, a display control method of an image-displaying sheet comprises:
detecting a copy operation performed on an image displayed on a display; and
switching OFF the mode to display an image on the display, if it is detected that the copy operation is performed.

According to a fourth aspect of the present invention, a display control method of an image-displaying sheet comprises:
accepting a copy start instruction given by a user to copy an image-displaying sheet placed on a document table of an image forming apparatus;
transmitting copy start signals to the image-displaying sheet from the image forming apparatus, if a copy start instruction is accepted; and
switching OFF the mode to display an image on the image-displaying sheet, in response to the copy start signals.

According to a fifth aspect of the present invention, a display control program stored in a computer readable recording medium to make a computer in an image-displaying sheet execute:
detecting a copy operation performed on an image displayed on a display; and
switching OFF the mode to display an image on the display, if the copy operation is detected.

According to a sixth aspect of the present invention, a display control program stored in a computer readable recording medium to make a computer in an image forming apparatus execute:
accepting a copy start instruction given by a user to copy an image-displaying sheet placed on a document table; and
transmitting copy start signals to the image-displaying sheet, if a copy start instruction is accepted.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram showing an electrical configuration of self-rewritable electronic paper that is an image-displaying sheet according to one embodiment of the present invention;

FIG. 2 is a plain view showing an exterior of the electronic paper;

FIG. 3 is a block diagram showing an electrical configuration of an image forming apparatus;

FIG. 4 is an overview showing a configuration of an image reader of the image forming apparatus;

FIG. 5 is a view to explain a scanning operation performed by the image reader;

FIG. 6 is a view to explain a detecting operation performed in the electronic paper when a scanning operation is started;

FIG. 7 is a table showing temporally-changing statuses of photo sensors that detect the start of scanning operation;

FIG. 8 is a view to explain a detecting operation performed in the electronic paper when a scanning operation is completed;

FIG. 9 is a view showing temporally-changing statuses of photo sensors that detect the completion of scanning operation;

FIG. 10 is a flowchart showing a procedure executed in the electronic paper, to explain a case where the mode to display an image on its display is switched OFF if the photo sensors detect a scanning operation.

FIG. 11 is a flowchart showing a procedure executed in the electronic paper, to explain a case where the mode to display an image on its display is switched OFF if the photo sensors detect a scanning operation, then the mode is switched ON again if the photo sensors detect the completion of scanning operation;

FIG. 12 is a sequence executed in the electronic paper, to switch ON and OFF the mode to display an image on its display;

FIG. 13 is a flowchart showing a procedure executed in the electronic paper, to explain a case where the mode to display an image on its display is switched OFF if a user authentication does not succeed and the photo sensors detect a scanning operation;

FIG. 14 is a flowchart showing a procedure executed in the image forming apparatus, to perform user authentication;

FIG. 15 is a sequence executed in the electronic paper, to switch OFF the mode to display an image on its display, if the start of copy operation is detected from copy start signals transmitted from the image forming apparatus;

FIG. 16 is a sequence executed in the electronic paper, to switch OFF the mode to display an image on its display is switched OFF if the start of copy operation is detected from copy start signals transmitted from the image forming apparatus, then switch ON again the mode if the completion of copy operation is detected from copy completion signals transmitted from the image forming apparatus;

FIG. 17 is a flowchart showing a procedure executed in the electronic paper to switch ON or OFF the mode to display an image on its display, if copy permit or copy prohibit is set on the electronic paper;

FIG. 18 is a flowchart showing a procedure executed in the image forming apparatus, to explain a case where the mode to display an image on a display of the electronic paper is switched OFF if copy start signals are transmitted from the image forming apparatus;

FIG. 19 is a flowchart showing a procedure executed in the image forming apparatus, to explain a case where the mode to display an image on a display of the electronic paper is switched OFF if copy start signals are transmitted from the image forming apparatus, then the mode is switched ON again if copy completion signals are transmitted from the image forming apparatus;

FIG. 20 is a view to explain a case where the mode to display an image on a display of the electronic paper is switched OFF if it is judged that the image is being copied by a digital camera equipped with an active auto focus system;

FIG. 21 is a plain view of an exterior of the electronic paper loaded with infrared sensors and ranging sensors;

FIG. 22 is a table showing detecting results drawn by the infrared sensors and the ranging sensors located in respective parts of the electronic paper; and

FIG. 23 is a flowchart showing a procedure executed in the electronic paper, to explain a case where the mode to display an image on its display is switched OFF if it is judged that the image is being copied by a digital camera, based on voltages detected by the infrared sensors and the ranging sensors.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

First, a structure of electronic paper will be briefly explained as an example of an image-displaying sheet.

Among various kinds of structures used for electronic paper, a sandwich structure of a filer layer, an ink layer, a driver layer and another filter layer is the most generally used as the principle of a display.

The ink layer has “microcapsules” containing liquid particles of two colors: white and blue, or “electrostatic beads” of which upper half is colored in white and lower half in blue. In both cases, frontside of electronic paper usually looks white in a normal condition.

The driver layer gives a negative charge to particular parts of the ink layer to form an image. If “microcapsules” are charged, white liquid particles are collected towards backside of electronic paper due to the electrophoretic phenomenon, meanwhile blue liquid particles are left towards frontside of electronic paper. The blue liquid particles left towards the frontside represent “black” elements to be shown on the electronic paper. Similarly, if “electrostatic beads” are charged, the beads are turned upside down. Respective beads represent “black” and “white” elements to be shown on electronic paper.

Further, the electronic paper may be of another type not having a driver layer, which is rewritten by an external device for the purpose of cost reduction and liberation from its shape and size.

This embodiment assumes self-rewritable electronic paper having a driver layer.

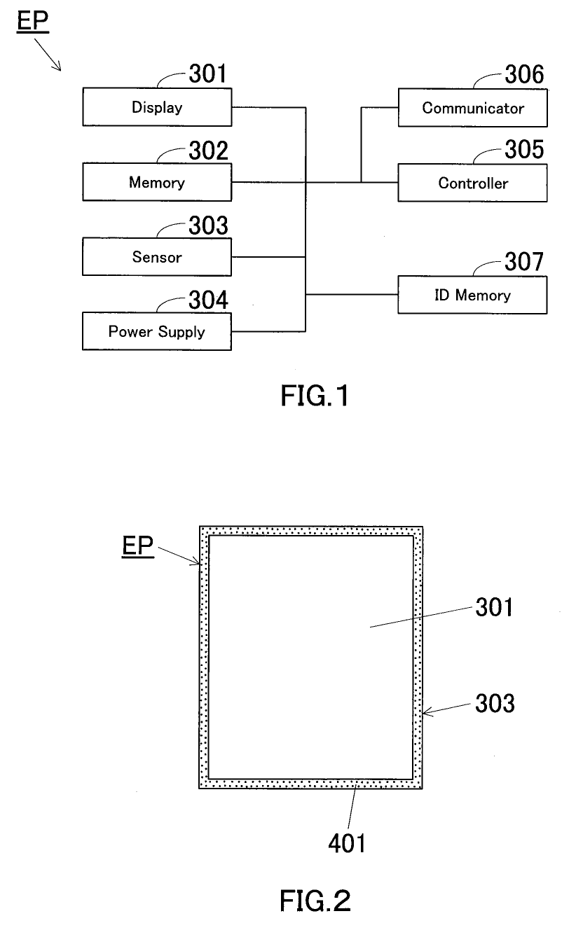

FIG. 1 is a block diagram showing an electrical configuration of self-rewritable electronic paper that is an image-displaying sheet according to one embodiment of the present invention.

As shown in FIG. 1, electronic paper EP comprises a display 301 that keeps an image (image data) displayed thereon without power, a memory 302 that stores an image therein, a sensor 303 that detects a copy operation performed on an image displayed on the display 301, a controller 305, a power supply 304 that provides power for the sensor 303 and the controller 305, a communicator 306 that communicates with an image forming apparatus M, for example receives a user (operator) ID, transmits an ID of the electronic paper EP, and receives copy start signals and copy completion signals from the image forming apparatus M, and an ID memory 307 that stores an ID given to the electronic paper EP.

The controller 305 controls the overall electronic paper EP, and comprises a CPU, a ROM and a RAM that are not shown in Figure. Further, the controller 305 makes the display 301 switch ON and OFF the mode to display an image thereon. Concretely, the controller 305 makes the display 301 hide an image displayed thereon, if it is detected that a copy operation is performed on the image, then makes the display 301 display again the image thereon, if the completion of copy operation is detected.

Further, the controller 305 compares a user ID acquired via the communicator 306 from the image forming apparatus M, and an ID of the electronic paper, which is stored in the ID memory 307. If the controller 305 judges those IDs are interrelated, then makes the display 301 keep ON the mode to display an image thereon.

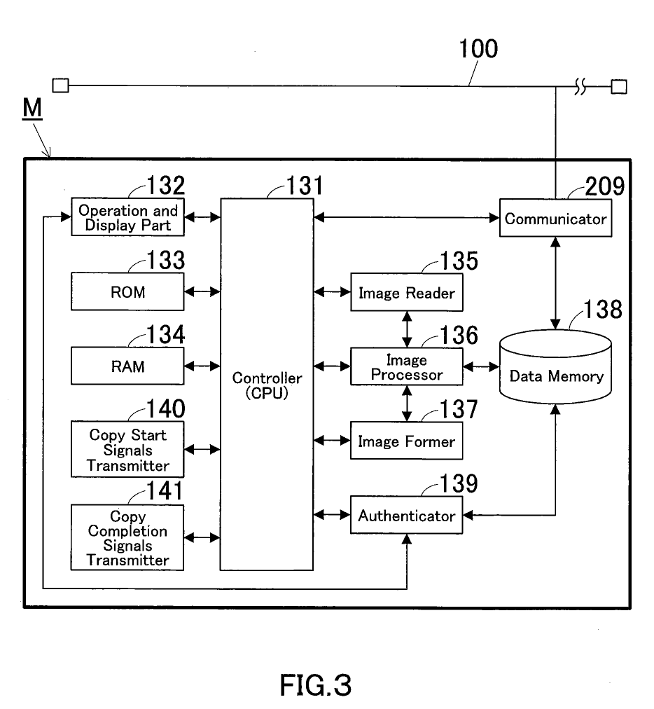

In the electronic paper EP having the configuration described above, the sensor 303 detects a copy operation performed by the image forming apparatus M (shown in FIG. 3) for example. If the sensor 303 detects a copy operation, the controller 305 makes the display 301 switch OFF the mode to display an image thereon. Concretely, in the electronic paper EP, the driver layer reverses the electrical polar of particular parts, where an image is formed on a matrix, and the positions of white and black particles are exchanged. Consequently, an image on the display 301 is hidden.

FIG. 2 is a plain view of an exterior of self-rewritable electronic paper ER

As shown in FIG. 2, the electronic paper EP has a margin 401 surrounding the display 301, where photo sensors 601 through 603 (shown in FIG. 6) and 604 through 606 (shown in FIG. 8) are provided.

As shown in FIG. 6, the photo sensors 601 through 603 are aligned in the sub-scanning direction in the scan start end of the electronic paper EP, so that the photo sensors could detect the start of a scanning operation performed by an image reader of the image forming apparatus M on an image displayed on the display 301. Similarly, as shown in FIG. 8, the photo sensors 604 through 606 are aligned in the sub-scanning direction in the scan finish end of the electronic paper EP, so that the photo sensors could detect the completion of scanning operation.

As a matter of course, positions and quantity of the photo sensors 601 through 603 and the photo sensors 604 though 606, can be arbitrarily determined as long as it does not interferes the visibility of an image displayed on the display.

FIG. 3 is a block diagram showing an electrical configuration of the image forming apparatus M.

As shown in FIG. 3, the image forming apparatus M comprises a controller 131 having a CPU and controlling the overall image forming apparatus M itself, an operation and display part 132 that performs various setting operations and displays a message and others thereon, a ROM 133 that stores an operating program for the controller 131 therein, a RAM 134 that provides an operating space for the controller 131, an image reader 135 that reads and computerizes an image on a document or the electronic paper EP placed on a document table 501 to be mentioned later, an image processor 136 that processes in a predetermined manner on the computerized image (image data), an image former 137 that prints the image data on a sheet, a data memory 138 that stores various kinds of data therein, an authenticator 139 that performs user authentication, a copy start signals transmitter 140 that transmits copy start signals to the electronic paper EP if a copy operation is started, a copy completion signals transmitter 141 that transmits copy completion signals to the electronic paper EP if a copy operation is completed, and a communicator 209 that exchanges data with an external device and others and receives an ID of the electronic paper EP, via a network 100.

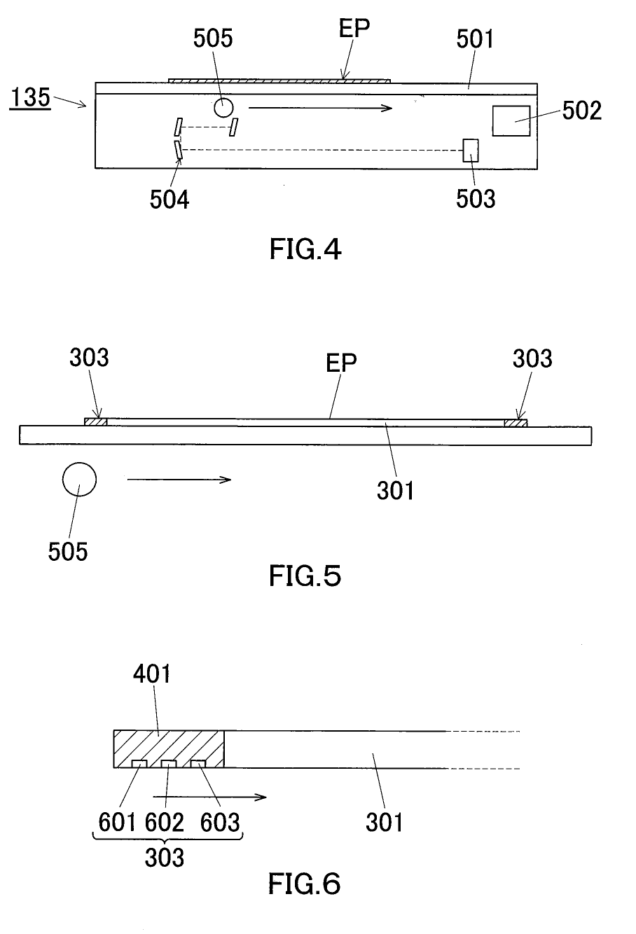

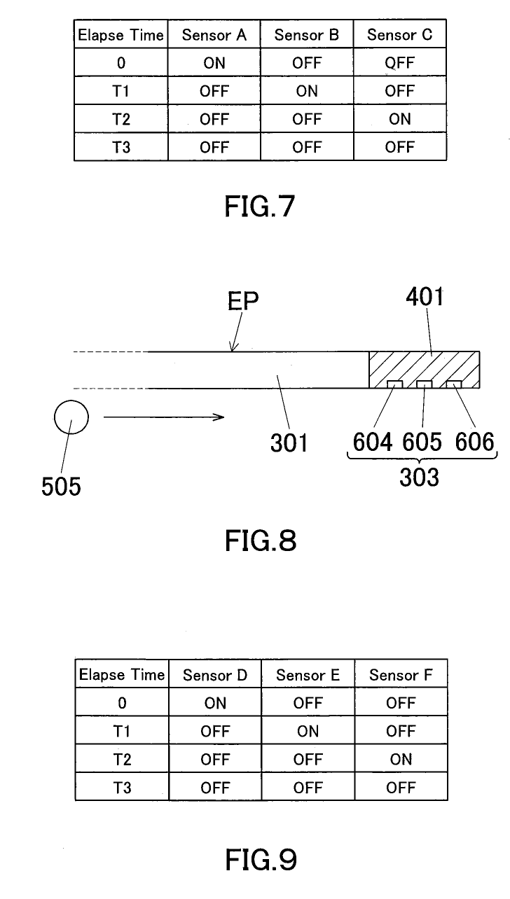

FIG. 4 is an overview showing a configuration of the image reader 135.

The image reader 135 comprises for example, a document table 501 on which the electronic paper EP is placed, a light source (lamp) 505 that light-irradiates an image on the electronic paper EP, a scanner motor 502 that slides the light source 505 in the sub-scanning direction (in the direction indicated by arrow), mirrors 504 that guide in a predetermined direction the light reflected from the electronic paper EP that is light-irradiated by the light source 505, and a CCD 503 that receives and photoelectrically converts the light collected by the mirrors 504 then transmits electrical signals.

Hereinafter, operations performed in the electronic paper EP if the image reader 135 of the image forming apparatus M is copying an image on the electronic paper EP, will be explained with reference to FIG. 5 and FIG. 6.

If the image reader 135 starts scanning an image on the electronic paper EP, the light source 505 slides in the sub-scanning direction as indicated by arrow in FIG. 5, and light-irradiates an image on the electronic paper EP placed on the document table 501.

As shown in FIG. 6, the photo sensor 601 (Sensor A), the photo sensor 602 (Sensor B) and the photo sensor 603 (Sensor C) aligned in the sub-scanning direction in the scan start end of the electronic paper EP, subsequently detect the light emitted by the light source 505. Then, it is judged that a scanning operation to copy an image on the display 301 is performed.

Concretely, if the photo sensor 601 (Sensor A) detects the light, its status is turned to ON. A T1 second later, if the photo sensor 602 (Sensor B) detects the light, its status is turned to ON as well as the status of the photo sensor 601 (Sensor A) is turned back to OFF.

And a T2 second later, if the photo sensor 603 (Sensor C) detects the light, its status is turned to ON as well as the status of the photo sensor 602 (Sensor B) is turned back to OFF.

And a T3 second later, if the photo sensor 603 (Sensor C) does not detect the light any more, its status is turned back to OFF. Meanwhile, the statuses of the photo sensor 601 (Sensor A) and the photo sensor 602 (Sensor B) remain OFF.

Based on the statuses right above, it is judged that the light source 505 is sliding and light-irradiating the display 301 of the electronic paper EP, in other words, the image reader 135 is performing a scanning operation.

Status of the photo sensor 601 (Sensor A) can still be ON after the T1 second when status of the photo sensor 602 (Sensor B) is turned to ON, depending on the setting value of T1 and physical intervals between the photo sensors 601 through 603 (Sensor A through Sensor C). Further, the number of sensors, physical intervals between the sensors, etc. can be arbitrarily determined.

Meanwhile, as shown in FIG. 8, the photo sensor 604 (Sensor D), the photo sensor 605 (Sensor E) and the photo sensor 606 (Sensor F) aligned in the sub-scanning direction in the scan finish end, subsequently detect the light emitted by the light source 505 sliding in the sub-scanning direction. Then, it is judged that a scanning operation to copy the display 30 of the electronic paper EP is completed.

Concretely, if the photo sensor 604 (Sensor D) detects the light emitted by the light source 505, its status is turned to ON. Then a T1 second later, if the photo sensor 605 (Sensor E) detects the light, it status is turned to ON as well as the status of the photo sensor 604 (Sensor D) is turned back to OFF.

And a T2 second later, if the photo sensor 606 (Sensor F) detects the light, its status is turned to ON as well as the status of the photo sensor 605 (Sensor E) is turned back to OFF.

And a T3 second later, if the photo sensor 606 (Sensor F) does not detect the light any more, its status is turned back to OFF. Meanwhile, the statuses of the photo sensor 604 (Sensor D) and the photo sensor 605 (Sensor E) remain OFF.

Depending on the setting value of T1 and physical intervals between the photo sensor 604 (Sensor D), the photo sensor 605 (Sensor E) and the photo sensor 606 (Sensor F), the status of the photo sensor 604 (Sensor D) can remain ON when the status of the photo sensor 605 (Sensor E) is turned to ON after the T1 second. In this way, the number of sensors, physical intervals between respective sensors, etc., can be arbitrarily determined.

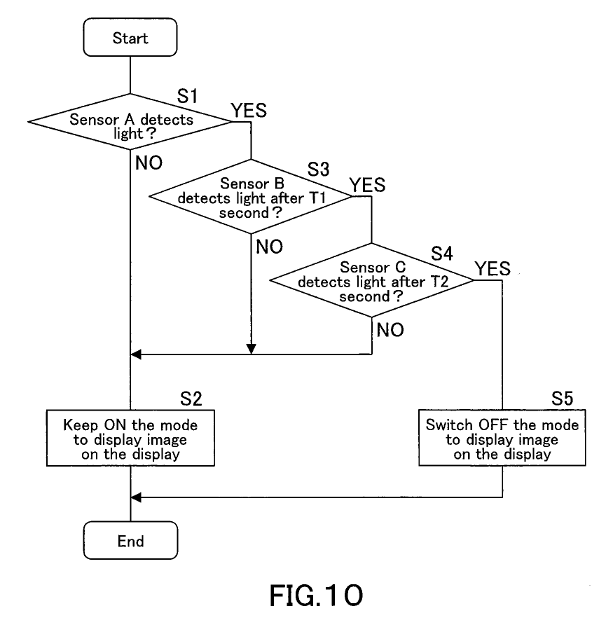

FIG. 10 is a flowchart showing a procedure executed in the electronic paper, to switch ON and OFF the mode to display an image on the display 301, depending on statuses of the photo sensor 601 (Sensor A), the photo sensor 602 (Sensor B) and the photo sensor 603 (Sensor C). The procedure is executed by a CPU of the controller 305 in the electronic paper EP according to a program stored in a recording medium not shown in Figure.

As shown in FIG. 10, it is judged in Step S1 whether or not the photo sensor 601 (Sensor A) detects the light emitted by the light source 505. If the photo sensor 601 (Sensor A) detects the light emitted by the light source 505 (YES in Step S1), the routine proceeds to Step S3. If the photo sensor 601 (Sensor A) does not detect the light emitted by the light source 505 (NO in Step S1), the mode to display an image on the display 301 is kept ON in Step S2, since the image is recognized as not being scanned. Then the routine terminates.

In Step S3, it is judged after a T1 second, whether or not the photo sensor 602 (Sensor B) detects the light emitted by the light source 505. If the photo sensor 602 (Sensor B) detects the light emitted by the light source 505 (YES in Step S3), the routine proceeds to Step S4. If the photo sensor 602 (Sensor B) does not detect the light emitted by the light source 505 (NO in Step S3), the routine returns to Step S2 for the process previously mentioned. Then the routine terminates.

In Step S4, it is judged after a T2 second, whether or not the photo sensor 603 (Sensor C) detects the light emitted by the light source 505. If the photo sensor 603 (Sensor C) detects the light emitted by the light source 505 (YES in Step S4), the mode to display an image on the display 301 is switched OFF in Step S5, since the image is recognized as being scanned. If the photo sensor 603 (Sensor C) does not detect the light emitted by the light source 505 (NO in Step S4), the routine returns to Step S2 for the process previously mentioned. Then the routine terminates.

As described above in this embodiment, if it is detected that a copy operation to copy an image displayed on the display 301 is being performed, the mode to display the image is switched OFF and the image is hidden. Thus, it could fully eliminate the risk of abusive copy and leakage of the image.

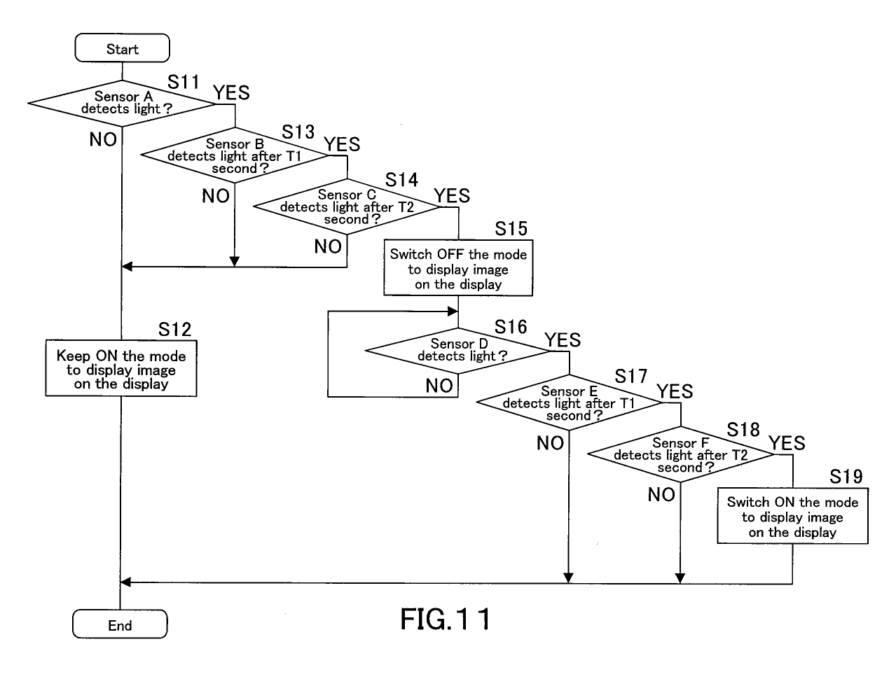

FIG. 11 is a flowchart showing a procedure, to explain a case where the mode to display an image on the display 301 is switched OFF if a scanning operation is detected, then the mode is switched ON again if the completion of copy operation is detected. The procedure is executed by the CPU of the controller 305 in the electronic paper EP according to an operation stored in a recording medium not shown in Figure.

As shown in FIG. 11, Steps S11 through S15 are exactly the same as Steps S1 through S5 shown in FIG. 10.

In Step S11, it is judged whether or not the photo sensor 601 (Sensor A) detects the light emitted by the light source 505. If the photo sensor 601 (Sensor A) detects the light emitted by the light source 505 (YES in Step S11), the routine proceeds to Step S13. If the photo sensor 601 (Sensor A) does not detect the light emitted by the light source 505 (NO in Step S11), the mode to display an image on the display 301 is kept ON in Step S12, since the image is recognized as not being scanned. Then the routine terminates.

In Step S13, it is judged after a T1 second, whether or not the photo sensor 602 (Sensor B) detects the light emitted by the light source 505. If the photo sensor 602 (Sensor B) detects the light emitted by the light source 505 (YES in Step S13), the routine proceeds to Step S14. If the photo sensor 602 (Sensor B) does not detect the light emitted by the light source 505 (NO in Step S13), the routine returns to Step S12 for the process previously mentioned. Then the routine terminates.

In Step S14, it is judged after a T2 second, whether or not the photo sensor 603 (Sensor C) detects the light emitted by the light source 505. If the photo sensor 603 (Sensor C) detects the light emitted by the light source 505 (YES in Step S14), the mode to display an image on the display 301 is switched OFF in Step S15, since the image is recognized as being scanned. If the photo sensor 603 (Sensor C) does not detect the light emitted by the light source 505 (NO in Step S14), the routine returns to Step S12 for the process previously mentioned. Then the routine terminates.

In Step S16, it is judged whether or not the photo sensor 604 (Sensor D) detects the light emitted by the light source 505. If the photo sensor 604 (Sensor D) detects the light emitted by the light source 505 (YES in Step S16), the routine proceeds to Step S17. If the photo sensor 604 (Sensor D) does not detect the light emitted by the light source 505 (NO in Step S16), the routine waits in Step S16 until the photo sensor 604 detects the light emitted by the light source 505.

In Step S17, it is judged after a T1 second, whether or not the photo sensor 605 (Sensor E) detects the light emitted by the light source 505. If the photo sensor 605 (Sensor E) detects the light emitted by the light source 505 (YES in Step S17), the routine proceeds to Step S18. If the photo sensor 605 (Sensor E) does not detect the light emitted by the light source 505 (NO in Step S17), the routine directly terminates.

In Step S18, it is judged after a T2 second, whether or not the photo sensor 606 (Sensor F) detects the light emitted by the light source 505. If the photo sensor 605 (Sensor F) detects the light emitted by the light source 505 (YES in Step S18), the routine proceeds to Step S19. In Step S19, the mode to display an image on the display 301 is switched ON, then the routine terminates.

If the photo sensor 606 (Sensor E) does not detects the light emitted by the light source 505 (NO in Step S18), the routine directly terminates.

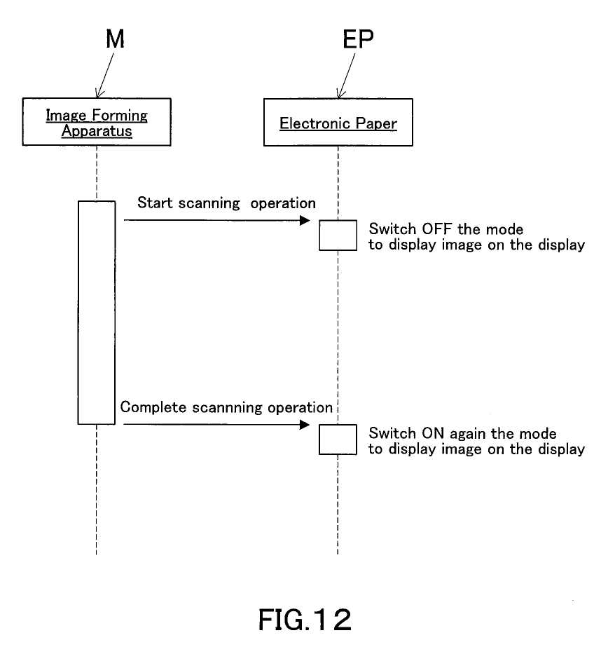

Repeatedly, this embodiment will be briefly outlined with reference to a sequence shown in FIG. 12. The mode to display an image on the display 301 is switched OFF, if it is judged that a scanning operation is started by the image forming apparatus M, based on statuses (ON or OFF) of the photo sensor 601 (Sensor A), the photo sensor 602 (Sensor B) and the photo sensor 603 (Sensor C) detecting the light emitted by the sliding light source 505. And then, the mode to display an image on the display 301 is switched ON, if it is judged that a scanning operation is completed, based on statuses (ON or OFF) of the photo sensor 604 (Sensor D), the photo sensor 605 (Sensor E) and the photo sensor 606 (Sensor F) detecting the light emitted by the sliding light source 505. Thus, a user owning the electronic paper EP does not suffer from the inconvenience, that is, once an image is hidden, never back again.

In this embodiment, another configuration can be used wherein user authentication is required for a user trying to use the image forming apparatus M to copy an image on the electronic paper EP, and the user is permitted to copy the image using the image forming apparatus M, in other words, the image on the electronic paper EP is kept displayed, if it is judged that a user ID acquired for user authentication and an ID of the electronic paper EP are interrelated in a predetermined manner. That is, if a user ID and an ID of the electronic paper EP are interrelated in a predetermined manner, it is recognized that a user trying to use the image forming apparatus is the owner of the electronic paper EP and the electronic paper EP is not the one abusively obtained.

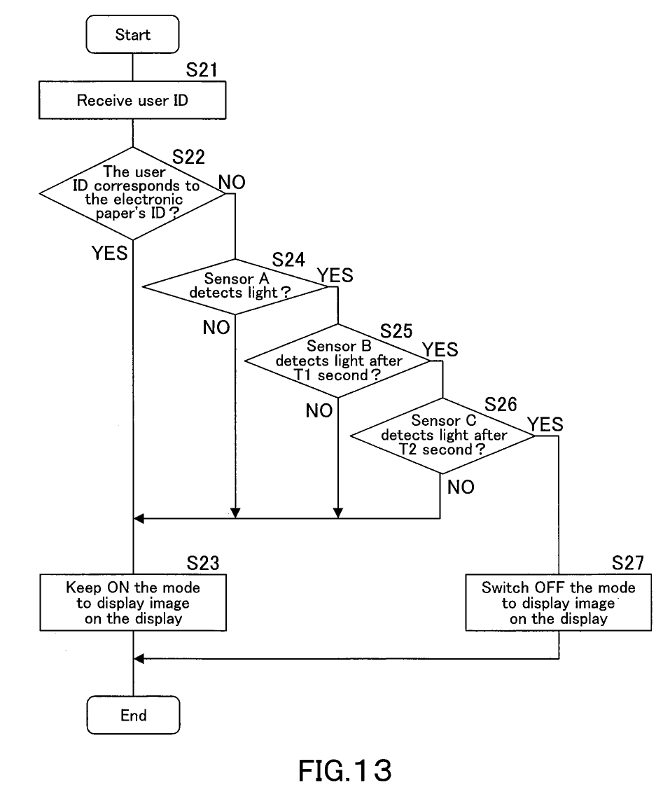

FIG. 13 is a flowchart showing a procedure executed in the electronic paper, to explain a case where the mode to display an image on its display is kept ON if it is judged that a user ID and an ID of the electronic paper EP are interrelated, as described above. The procedure is executed by the CPU of the controller 305 in the electronic paper EP according to a program stored in a recording medium not shown in Figure.

In FIG. 13, the image forming apparatus M performs user authentication, then transmits the user ID used for the user authentication to the electronic paper EP.

The user ID is received from the image forming apparatus M in Step S21. Then it is judged in Step S22 whether or not the received user ID corresponds to an ID of the electronic paper EP, which is stored in the ID memory 307.

If the received user ID corresponds to an ID of the electronic paper EP (YES in Step S22), the mode to display an image on the display 301 is kept ON in Step S23, since the user is recognized as the owner of the electronic paper EP. In this case, the user is permitted to copy the image.

If the received user ID does not correspond to an ID of the electronic paper EP (NO in Step S22), the routine proceeds to Step S24.

In Step S24, it is judged whether or not the photo sensor 601 (Sensor A) detects the light emitted by the light source 505. If the photo sensor 601 (Sensor A) detects the light emitted by the light source 505 (YES in Step S24), the routine proceeds to Step S25. If the photo sensor 601 (Sensor A) does not detect the light emitted by the light source 505 (NO in Step S24), the routine returns to Step S23 for the process previously mentioned, since an image on the display 301 is recognized as not being scanned. Then the routine terminates.

In Step S25, it is judged after a T1 second, whether or not the photo sensor 602 (Sensor B) detects the light emitted by the light source 505. If the photo sensor 602 (Sensor B) detects the light emitted by the light source 505 (YES in Step S25), the routine proceeds to Step S26. If the photo sensor 602 (Sensor B) does not detect the light emitted by the light source 505 (NO in Step S25), the routine returns to Step S23 for the process previously mentioned. Then the routine terminates.

In Step S26, it is judged after a T2 second, whether or not the photo sensor 603 (Sensor C) detects the light emitted by the light source 505. If the photo sensor 603 (Sensor C) detects the light irradiated by the light source 505 (YES in Step S26), the mode to display an image on the display 301 is switched OFF in Step S27, since the image is recognized as being scanned. If the photo sensor 604 (Sensor C) does not detect the light emitted by the light source 505 (NO in Step S26), the routine returns to Step S23 for the process previously mentioned. Then the routine terminates.

As described above in this embodiment, the mode to display an image on the display 301 is kept ON if it is judged that a user ID and an ID of the image-displaying sheet correspond to each other. Thus, a user owning the electronic paper EP copies an image displayed thereon without any problem, and user convenience is improved.

In FIG. 13, the mode to display an image on the display is kept ON and the user is permitted to copy the image if it is judged a user ID and an ID of the electronic paper EP correspond to each other. However, those do not necessarily correspond to each other. Alternatively, those should be interrelated in a predetermined manner.

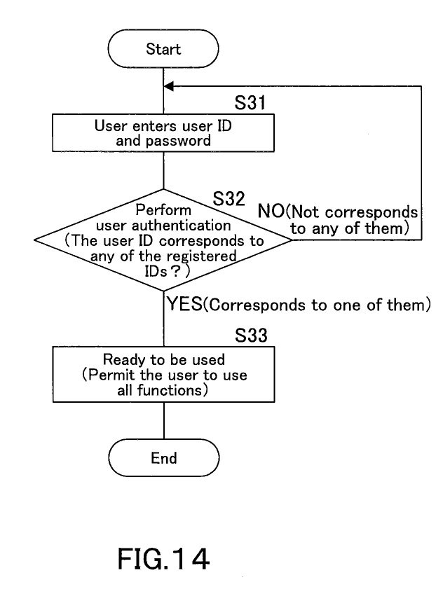

FIG. 14 is a flowchart showing a procedure executed in the image forming apparatus M to perform user authentication, when a user is trying to use the image forming apparatus M.

As shown in FIG. 14, a user enters a user ID and a password for user authentication, via the operation and display part 132 of the image forming apparatus M, in Step S31. Then in Step S32, it is judged whether or not to permit the user to use some functions of the image forming apparatus M, in other words, it is judged by the authenticator 139 whether or not the entered user ID corresponds to any of the registered IDs.

If the entered user ID does not correspond to any of the registered IDs (NO in Step S32), the routine returns to Step S31 to wait until a user ID and a password are entered again. If the entered user ID corresponds to any of the registered IDs (YES in Step S32), the user is permitted to use some functions of the image forming apparatus M and the image forming apparatus M is ready to be used, in Step S33. At the same time, the user ID is transmitted to the electronic paper EP, and it is received in Step S21 shown in FIG. 13.

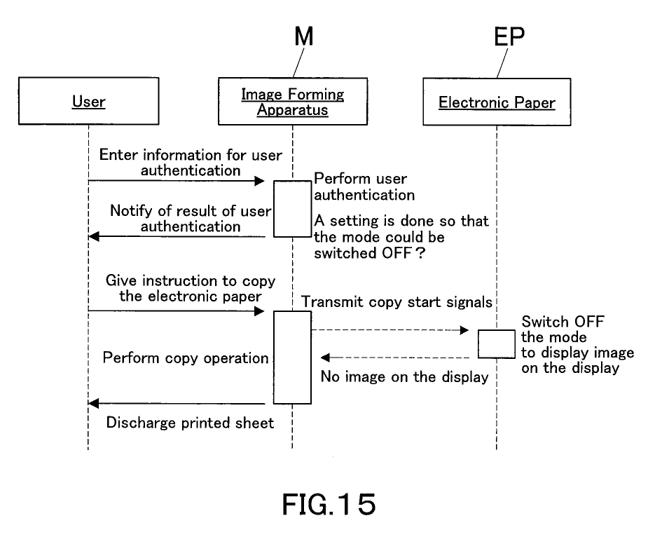

FIG. 15 is to explain another embodiment, and is a sequence executed in the electronic paper EP, to switch OFF the mode to display an image on the display 301, if copy start signals are received from the image forming apparatus M.

As shown in FIG. 15, a user performs an entry operation for user authentication on the image forming apparatus M, then user authentication is performed in the image forming apparatus M. And then the user is notified of a result of user authentication, in other words, the user is notified of permission or prohibition of using the image forming apparatus M.

In stead of using the configuration shown in FIG. 15, it can be configured such that even if user authentication succeeds, the image forming apparatus M does not transmit copy start signals (to be mentioned later) to the electronic paper EP so that the electronic paper EP could not switch OFF the mode to display an image on the display 301. Meanwhile, in FIG. 15, if user authentication succeeds, the image forming apparatus M transmit copy start signals to the electronic paper EP so that the electronic paper EP could switch OFF the mode to display an image on the display 301.

The user permitted to use the image forming apparatus M places the electronic paper EP on the document table 501 of the image forming apparatus M, then presses a start button. And then, the image forming apparatus M starts a scanning operation, in other words, starts scanning an image displayed on the display 301 of the electronic paper EP.

At the same time, the image forming apparatus M transmits copy start signals to the electronic paper ER Receiving the copy start signals, the electronic paper EP switches OFF the mode to display an image on the display 301.

Subsequently, the image forming apparatus M performs a regular copy process then discharges a printed sheet.

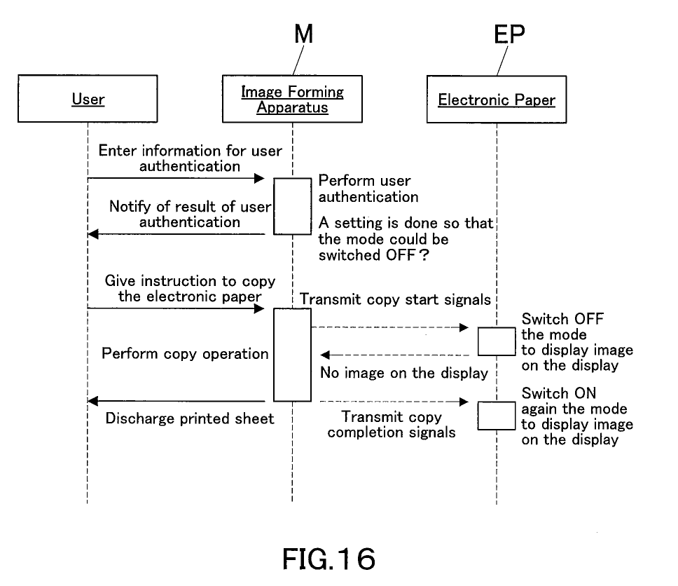

FIG. 16 is a sequence executed in the electronic paper EP, to switch OFF the mode to display an image on the display 301, if the start of copy operation is detected from copy start signals received from the image forming apparatus M, then switch ON the mode again if the completion of copy operation is detected from copy completion signals received from the image forming apparatus M.

As shown in FIG. 16, a user performs an entry operation for user authentication on the image forming apparatus M, then user authentication is performed in the image forming apparatus M. And then, the user is notified of a result of user authentication, in other words, the user is notified of permission or prohibition of using the image forming apparatus M.

The user permitted to use the image forming apparatus M places the electronic paper EP on the document table 501 of the image forming apparatus M, then presses a start button. And then, the image forming apparatus starts a scanning operation, in other words, starts scanning an image displayed on the display 301 of the electronic paper EP.

At the same time, the image forming apparatus M transmits copy start signals to the electronic paper EP.

Subsequently, the image forming apparatus M performs a regular copy process then discharges a printed sheet. Completing a copy operation, the image forming apparatus M transmits copy completion signals to the electronic paper ER Receiving the copy completion signals, the electronic paper EP switches ON again the mode to display an image on the display 301.

Alternatively, copy permit or copy prohibit can be set in advance on the electronic paper EP itself, so that an image on the display 301 could or could not be copied.

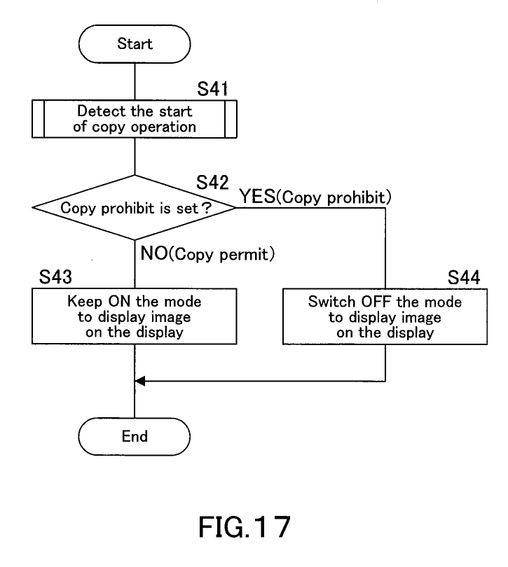

FIG. 17 is a flowchart showing a procedure to switch ON or OFF the mode to display an image on the display 301, if copy permit or copy prohibit is set on the electronic paper ER The procedure is executed by the CPU of the controller 305 in the electronic paper EP.

As shown in FIG. 17, it is detected that the image forming apparatus M starts a copy operation, in Step S41. Then in Step S42, it is judged whether or not copy prohibit is set.

If copy prohibit is not set (NO in Step S42), the mode to display an image on the display 301 is kept ON in Step S43. If copy prohibit is set (YES in Step S42), the mode to display an image on the display 301 is switched OFF in Step S44.

In this embodiment, as long as copy prohibit is not set, the mode is not switched OFF even if the start of copy operation is detected. Thus, a user simply sets copy prohibit on electronic paper to ensure safety, and feels free about use of electronic paper.

Further, another configuration can be used wherein the image forming apparatus M acquires an ID of the electronic paper EP when copying the electronic paper EP, then judges whether or not the acquired ID is related to a user ID entered for user authentication, and then the mode to display an image on the display 301 is switched ON or OFF depending on the judgment result.

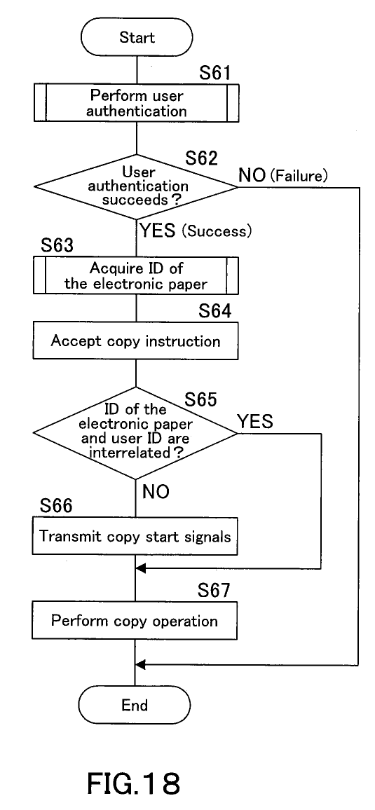

Hereinafter, a procedure executed in the image forming apparatus M using the configuration right above, will be explained with reference to a flowchart shown in FIG. 18.

As shown in FIG. 18, user authentication is performed in Step S61, and it is judged in Step S62 whether or not user authentication succeeds. If user authentication succeeds (YES in Step S62), the routine proceeds to Step S63. If user authentication fails (NO in Step S62), the routine directly terminates without giving usage permission to the user.

In Step S63, an ID is acquired from the electronic paper ER Then, the user places the electronic paper EP on the document table 501 then presses a start button. The copy instruction is accepted in Step S64, then the routine proceeds to Step S65.

In Step S65, it is judged whether or not an ID of the electronic paper EP and a user ID entered for user authentication are interrelated. If those are not interrelated (NO in Step S65), copy start signals are transmitted to the electronic paper EP in Step S66, since the user is not recognized as the owner of the electronic paper EP and might be trying to use it abusively. Then, a copy operation is performed in Step S67. Receiving copy start signals from the electronic paper EP, the electronic paper EP switches OFF the mode to display an image on the display 301.

If an ID of the electronic paper EP and a user ID entered for user authentication are interrelated (YES in Step S65), the routine directly proceeds to Step S67. In Step S67, the mode to display an image on the electronic paper 301 is kept ON and a copy operation is performed, since the user is recognized as the owner of the electronic paper EP and not trying to use it abusively. In this case, the image is kept displayed on the display 301 and the user is permitted to copy the image.

As described above in this embodiment, the image forming apparatus M does not transmit copy start signals to an image-displaying sheet if it is judged that an ID of the electronic paper EP and a user ID are interrelated. Thus, the image is kept displayed if there is no risk from being abusively copied.

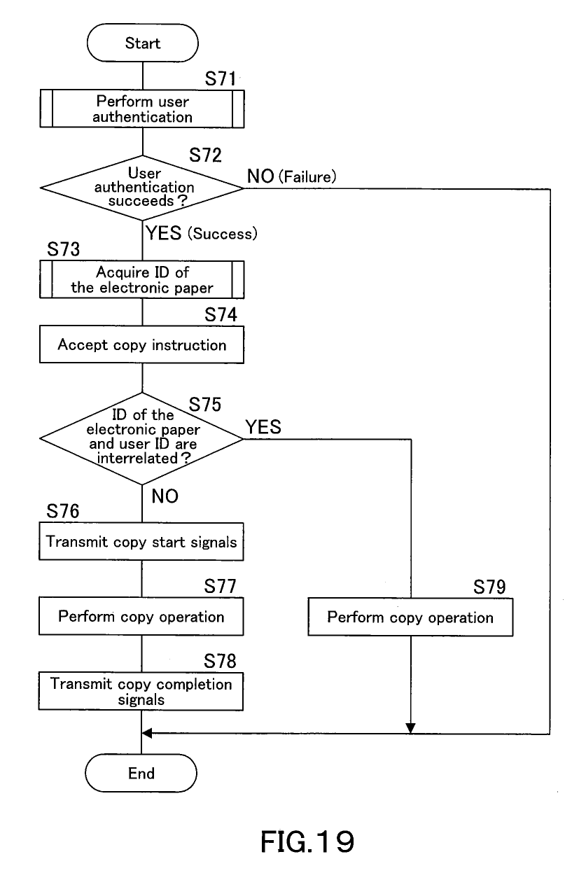

FIG. 19 is a flowchart showing a procedure executed in the image forming apparatus M, which includes the processes explained with reference to FIG. 18, further to explain a case where copy completion signals are transmitted to the electronic paper EP after the completion of copy operation.

User authentication is performed in Step S71, and it is judged in Step S72 whether or not to user authentication succeeds. If user authentication succeeds (YES in Step S72), the routine proceeds to Step S73. If user authentication fails (NO in Step S73), the routine directly terminates without giving usage permission to the user.

In Step S73, an ID is acquired from the electronic paper ER Then, the user sets the electronic paper EP on the document table 501 and presses a start button. A copy instruction is accepted in Step S74, then the routine proceeds to Step S75.

In Step S75, it is judged whether or not an ID of the electronic paper EP and a user ID entered for user authentication are interrelated. If those are interrelated (YES in Step S75), the routine directly proceeds to Step S79. In Step S79, the mode to display an image on the display 301 is kept ON and a copy operation is performed, since the user is recognized as the owner of the electronic paper EP and not trying to use it abusively. In this case, the image is kept displayed on the display 301 and the user is permitted to copy the image.

If an ID of the electronic paper EP and a user ID entered for user authentication are not interrelated (NO in Step S75), copy start signals are transmitted to the electronic paper EP in Step S76, since the user is not recognized as the owner of the electronic paper EP and might be trying to use it abusively. Then, a copy operation is performed in Step S77. Receiving copy start signals from the image forming apparatus M, the electronic paper EP switches OFF the mode to display an image on the display 301.

When a copy operation is completed, copy completion signals are transmitted to the electronic paper EP in Step S78. Receiving copy completion signals, the electronic paper EP switches ON again the mode to display an image on the display 301.

In this embodiment explained above, the procedure is executed if an image displayed on the display 301 of the electronic paper EP is copied by the image forming apparatus M. Alternatively, the mode to display an image on the display 301 of the electronic paper EP is switched OFF if the image is copied by a digital camera, as shown in an embodiment to be described below.

In recent years, compact digital cameras and single-lens reflex digital cameras are normally equipped with an auto focus system, and even cellular phones with a camera have this system.

Depending on its principles, auto focus systems are broadly classified into two methods: an active method and a passive method.

An active method is based on a principle of the laser radar technology, wherein ultrasonic or infrared light is emitted to an object, and a distance to the object is calculated based on the time it took the light to reach back and the irradiation angle, and then the focus is automatically adjusted. The method is normally employed for compact digital cameras.

In a passive method, a distance to an object is calculated using an image captured by lens, not using infrared light, etc. For example, the passive method includes a phase difference detection method employed for AF single-lens cameras and a phase contrast method employed for digital cameras.

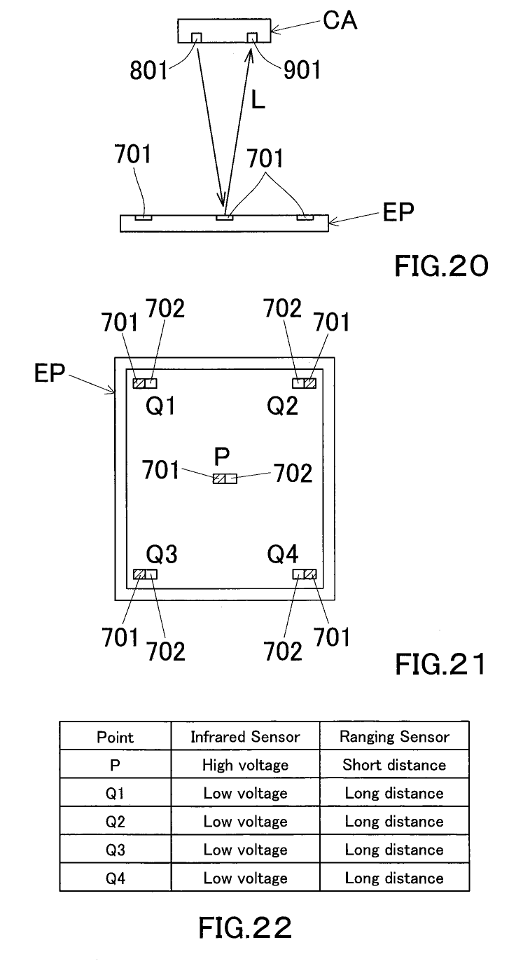

In this embodiment to be explained below, the mode to display an image on the display 301 is switched OFF if it is detected that an image on the display 301 in the electronic paper EP is being copied (shot) by a digital camera CA equipped with an active auto focus system. The procedure will be explained with reference to FIG. 20.

As shown in FIG. 20, the digital camera CA comprises an infrared irradiation part 801 that is an infrared LED emitting infrared light L to the electronic paper EP, and an infrared sensor 901 that receives the light reflected from the electronic paper.

The electronic paper EP comprises infrared sensors 701 that receive the infrared light L emitted from the digital camera CA.

If the digital camera CA shoots the display 301 of the electronic paper EP, the infrared sensors 701 in the electronic paper EP detect the infrared light L emitted from the digital camera CA. Based on the detecting results, it is judged that the digital camera CA is shooting an image on the display 301, then the mode to display the image is switched OFF.

FIG. 21 is an example of the electronic paper EP loaded with the infrared sensors 701 and ranging sensors 702.

As shown in FIG. 21, the respective infrared sensors 701 are provided in the center P and the four corners Q1 through Q4 of the display 301 of the electronic paper EP.

As a matter of course, positions and the number of the infrared sensors 701 can be arbitrarily determined.

Further, the respective ranging sensors 702 are provided beside the infrared sensors 701. The ranging sensor 702 emits light on a constant basis or emits light if receives the infrared light L emitted from the digital camera CA.

By comparing light levels and ranging values detected by the infrared sensors 701 and the ranging sensors 702 located in the parts P and Q1 through Q4, it is judged that the infrared light L is emitted from a particular angle and position. Then, an image on the display 301 is hidden.

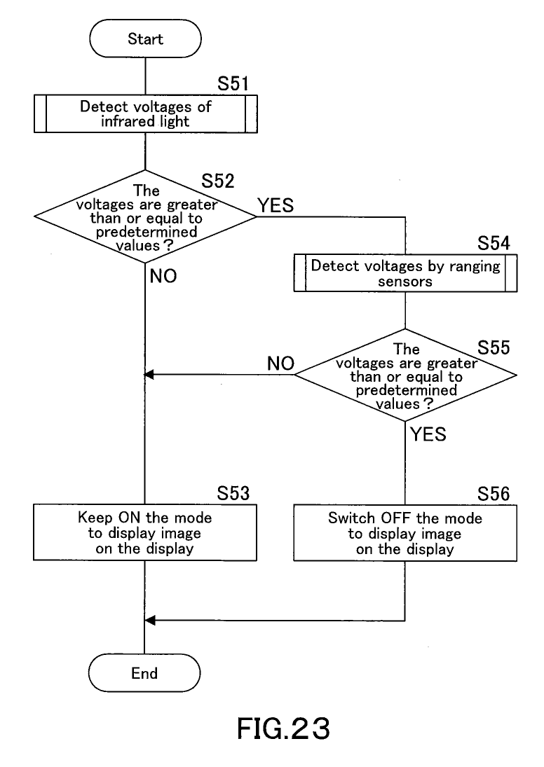

FIG. 23 is a flowchart showing a procedure to switch OFF the mode to display an image on the display 301, if it is judged that a digital camera is shooting the image, based on voltages detected by the infrared sensors 701 and the ranging sensors 702.

As shown in FIG. 23, voltages indicated by the infrared sensors 701 of the electronic paper EP are detected in Step S51. In Step S52, it is judged whether or not the detected voltages are greater than or equal to predetermined values. If the detected voltages are less than predetermined values (NO in Step S52), the mode to display an image on the display 301 is kept ON in Step S53, since it is recognized that the digital camera is not shooting the image.

If the detected voltages are greater or equal predetermined values (YES in Step S52), the routine proceeds to Step S54 where voltages indicated by the ranging sensors 702 of the electronic paper EP are detected. Then, it is judged in Step S55 whether or not the detected voltages are greater than or equal to predetermined values. If the detected voltages are less than predetermined values (NO in Step S55), the mode to display an image on the display 301 is kept ON in Step S53, since it is recognized that the digital camera is not shooting the image.

If the detected voltages are greater than or equal to predetermined values, the mode to display an image on the display 301 is switched OFF, since it is recognized that the digital camera is shooting the image.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image-displaying sheet, comprising:
a display that displays an image thereon;
a switch part that switches ON and OFF the mode to display an image on said display;
a copy detector that detects a copy operation performed on an image displayed on said display; and
a controller that makes said switch part switch OFF the mode to display an image on said display, if the copy detector detects that a copy operation is performed on the image.

2. The image-displaying sheet as recited in claim 1, wherein said copy detector further detects the completion of a copy operation performed on an image displayed on the display, and said controller further makes said switch part switch ON again the mode to display an image on the display, if the completion of the copy operation is detected.

3. The image-displaying sheet as recited in claim 1, wherein said copy operation is a scanning operation that is performed by sliding light emitted by a light source to an image displayed on said display, and said copy detector is a light sensor that detects said sliding light emitted by a light source.

4. The image-displaying sheet as recited in claim 1, further comprising:
an ID acquirer that acquires an ID of an operator; and
a judger that judges whether or not said acquired ID of an operator and an ID of
the image-displaying sheet are interrelated, and
wherein said controller keeps ON the mode to display an image on said display, if it is judged during the copy operation, that the ID of an operator and the ID of the image-forming apparatus are interrelated.

5. The image-displaying sheet as recited in claim 1, further comprising:
an infrared sensor that detects level of infrared light emitted to an image displayed on said display; and
a ranging sensor that detects a distance to a photographic device that shoots and copies an image displayed on said display, by emitting infrared light to the photographic device, and
wherein said copy detector detects a copy operation, based on detecting results drawn by said infrared sensor and said ranging sensor.

6. The image-displaying sheet as recited in claim 1, wherein said copy detector detects a copy operation performed on an image displayed on said display, by receiving copy start signals transmitted from an image forming apparatus.

7. The image-displaying sheet as recited in claim 2, wherein said copy detector detects the completion of a copy operation performed on the image, by receiving copy completion signals transmitted from an image forming apparatus.

8. An image forming apparatus, comprising:
an acceptor that accepts a copy start instruction given by a user to copy an image-displaying sheet placed on a document table; and
a controller that makes copy start signals transmitted to said image-displaying sheet, if a copy start instruction is accepted.

9. The image forming apparatus as recited in claim 8, wherein said controller further makes copy completion signals transmitted to said image-displaying sheet.

10. The image forming apparatus as recited in claim 8, further comprising:
an authenticator that authenticates the validity of said user;
an ID acquirer that acquires an ID of said image-displaying sheet; and
a judger that judges whether or not said acquired ID of the image-displaying sheet
and a user ID used for user authentication are interrelated, and
wherein copy start signals are not transmitted to said image-displaying sheet, if it is judged that an ID of the image-displaying sheet and said user ID are interrelated in a predetermined manner.

11. A display control method of an image-displaying sheet, comprising:
detecting a copy operation performed on an image displayed on a display; and
switching OFF the mode to display an image on said display, if it is detected that said copy operation is performed.

12. A display control method of an image-displaying sheet, comprising:
accepting a copy start instruction given by a user to copy an image-displaying sheet placed on a document table of an image forming apparatus;
transmitting copy start signals to said image-displaying sheet from the image forming apparatus, if a copy start instruction is accepted; and
switching OFF the mode to display an image on the image-displaying sheet, in response to said copy start signals.

13. A display control program stored in a computer readable recording medium to make a computer in an image-displaying sheet execute:
detecting a copy operation performed on an image displayed on a display; and
switching OFF the mode to display an image on said display, if said copy operation is detected.
